(19) United States
(12) Patent Application Publication
(10) Pub. No.: US 2023/0388730 A1
(43) Pub. Date: Nov. 30, 2023

(54) Method for providing audio data, and associated device, system and computer program

(71) Applicant: ORANGE, Issy-les-Moulineaux (FR)

(72) Inventors: Chantal Guionnet, Chatillon Cedex (FR); Jean-Bernard Leduby, Chatillon Cedex (FR)

(21) Appl. No.: 18/325,448

(22) Filed: May 30, 2023

(30) Foreign Application Priority Data
May 31, 2022 (FR) 2205218

(51) Int. Cl. H04S 3/00; G10L 13/02

(52) U.S. Cl. CPC H04S 3/008; G10L 13/02; H04S 2400/01

(57) ABSTRACT

A method for providing audio data, and associated device, system, and computer program. The proposed method includes the generation of second audio data representative of at least one activity detected based on data measured by at least one sensor. The second generated audio data is adapted to be mixed with first captured audio data.

### TECHNICAL FIELD

This invention relates to the fields of capturing, processing and reproduction of audio data. In particular, this invention relates to a method for providing audio data, along with associated device, system, computer program and information medium. This invention applies advantageously to, but is not limited to, the implementation of videoconferencing systems, for example to equip meeting rooms.

### BACKGROUND OF THE INVENTION

In a known manner, a videoconferencing service is a service providing the real-time transmission of speech signals (i.e. audio streams) and video images (i.e. video streams) of interlocutors located in two different places (i.e. point-to-point communication) or more (i.e. point-to-multipoint communication). In a professional scope, videoconferencing services conventionally rely on the use of purpose-built videoconferencing rooms, specially equipped for this purpose.

Videoconferencing services offer many advantages for business and individuals. They offer an advantageous alternative to in-person meetings, particularly in terms of cost and time, by making it possible to limit physical travel by the attendees. These advantages are however counterbalanced by a certain number of drawbacks.

In particular, existing videoconferencing solutions are not fully satisfactory as regards digital accessibility. The users of existing videoconferencing services encounter varying degrees of difficulty in following a remote meeting due to their languages, aptitudes, computer hardware and, more generally, their digital resources. Specifically, existing videoconferencing systems of necessity require multimodal reproduction, with a video stream and an audio stream, to allow users to have a good understanding of a meeting. By way of example, when the video stream retransmitted during a videoconference corresponds to the slides of a presentation, remote users may encounter difficulties following the various interventions of the interlocutors or in understanding a conversation between several people.

There is consequently a need for a solution for reproducing the progress of a videoconferencing meeting in a more complete and accessible manner, and thus making it possible to improve the experience of the users of a videoconferencing system.

### SUMMARY OF THE INVENTION

This invention is directed to overcoming all or part of the drawbacks of the prior art, in particular those described previously.

For this purpose, according to an aspect of the invention, a method is proposed for providing audio data, said method comprising an audio generation, the audio generation creating second audio data representative of at least one detected activity, said at least one activity being detected based on data measured by at least one non-audio sensor, the second generated audio data being adapted to be mixed with first captured audio data.

The proposed method allows to improve the reproduction of a meeting or a presentation and also to improve digital accessibility to videoconferencing services. More specifically, the proposed method allows to describe by the sole audio modality the detected activities during a meeting or a presentation, these activities being normally accessible by several modes, in particular audio and video modes.

According to an embodiment, the method comprises sensing the data measured by said at least one sensor based on which said at least one activity is detected.

This embodiment allows to obtain the measured data necessary for the detection of the activities associated with a meeting or a presentation. By adapting the method of sensing of the measured data, this embodiment allows to adapt the detection of the associated activities to a meeting or a presentation in relation to different scenarios.

According to an embodiment, the second audio data comprise at least one audio message in speech synthesis.

This embodiment allows to describe the detected activities to the users using speech signals and therefore to describe these activities more explicitly.

According to an embodiment, the method comprises mixing the first audio data and the second audio data.

This embodiment allows to combine, in a single audio channel, the first captured audio data associated with a meeting or with a presentation and the second audio data representative of the detected activities related to this meeting or presentation.

More precisely, this embodiment allows to enrich an audio content (e.g. the sounds captured by the microphones of a room) associated with a meeting or a presentation with audio data representative of the activities detected during this meeting or presentation.

According to an embodiment, the mixing of the first audio data and second audio data is performed synchronously.

This embodiment allows to synchronize the audio data of activities (i.e. second audio data) with the base audio data (i.e. first audio data). By performing the mixing synchronously, when the enriched audio data (i.e. mixed audio data) are reproduced to a user, the latter has access simultaneously to the base audio data and to the activities audio data, which improves the reproduction of a meeting by the audio modality.

According to an embodiment, the generation of second audio data representative of an activity is immediately consecutive to the detection of this activity and the mixing of the first audio data and of the second audio data is immediately consecutive to the generation of the second audio data.

This embodiment allows a user to receive live audio data enriched with activity data.

According to an embodiment, the mixed audio data comprise several audio channels.

This embodiment allows to provide different versions of an audio content associated with a

meeting or a presentation.

According to an embodiment, the generation of the second audio data is performed as a function of at least one user parameter of a user of a reproduction device that is a recipient of the mixed audio data.

This embodiment is particularly advantageous insofar as it allows to adapt the enriched audio content as a function of the recipient.

Hence, this embodiment also allows to improve the digital accessibility of videoconferencing systems. Specifically, the audio stream during a videoconference is enriched with activity data adapted to the recipients, which allows to improve the experience of the users of a videoconferencing system.

According to an embodiment, said several audio channels are respectively obtained as a function of different user parameters.

This embodiment allows to adapt the reproduction of a meeting or of a presentation to users with different user parameters, which contributes to improving the experience of the users.

According to an embodiment, the method comprises identifying at least one person associated with said at least one detected activity, said second audio data being generated based on the result of said identifying.

According to this embodiment, the proposed method allows to detect the activities of persons involved in a meeting or in a presentation and also allows to identify these persons. The activity audio data are, according to this embodiment, obtained based on the identification of the persons.

By identifying the persons associated with the activities described by the activity audio data, this embodiment allows to reproduce a meeting or presentation in a more complete manner (i.e. with a greater level of information) via the audio modality.

According to another aspect of the invention, a device is proposed for providing audio data, said device comprising an audio generator, the audio generator creating second audio data representative of at least one detected activity, said at least one activity being detected based on data measured by at least one non-audio sensor, said second generated audio data being adapted to be mixed with first captured audio data.

The features and advantages of the method in accordance with this invention described above are also applicable to the proposed device and vice versa.

According to an aspect of the invention, a system is proposed comprising:
a device for providing audio data in accordance with the invention; and
at least one capturing device configured to capture first audio data and to communicate with said device for providing audio data; and
at least one sensor configured to sense measured data and to communicate with said device for providing audio data.

The features and advantages of the method in accordance with this invention described above are also applicable to the proposed system and vice versa.

According to an embodiment, the system comprises at least one reproduction device configured to communicate with said device for providing audio data and to reproduce audio data.

According to an embodiment, said at least one sensor is a sensor from among the following: a video camera; a network probe; a pressure sensor; a temperature sensor; a depth sensor; and a thermal camera.

According to an embodiment, the proposed system is a videoconferencing system. In particular, according to this embodiment, the proposed system implements a video conferencing service (i.e. a video conferencing function).

According to an aspect of the invention, a computer program is proposed including instructions for implementing the steps of a method in accordance with the invention, when the computer program is executed by at least one processor or one computer.

The computer program can be formed from one or more sub-parts stored in one and the same memory or in separate memories. The program can use any programming language and be in the form of source code, object code, or intermediate code between source code and object code, such as in a partially compiled form, or in any other desirable form.

According to an aspect of the invention, a recording medium readable by a computer is proposed, comprising a computer program in accordance with the invention.

The information medium can be any entity or device capable of storing the program. For example, the medium may include a storage means, such as a non-volatile memory or ROM, for example a CD-ROM or a microelectronic circuit ROM, or else a magnetic recording means, for example a floppy disk or a hard disk. Moreover, the storage medium can be a transmissible medium such as an electrical or optical signal, which can be conveyed via an electrical or optical cable, by radio or by a telecommunications network or by a computer network or by other means. The program according to the invention can in particular be downloaded over a computer network. Alternatively, the information medium can be an integrated circuit into which the program is incorporated, the circuit being suitable for executing or for being used in the execution of the method in question.

### BRIEF DESCRIPTION OF THE DRAWINGS

Other features and advantages of this invention will become apparent from the description given hereinafter of embodiments of the invention. These embodiments are given by way of example and are without any limitation. The description provided below is illustrated by the appended drawings:

FIG. 1 schematically represents a system for providing audio data according to an embodiment of the invention;

FIG. 2 represents, in the form of a block diagram, the steps of a method for providing audio data according to an embodiment of the invention;

FIG. 3 schematically represents an example of data obtained and processed by a system for providing audio data according to an embodiment of the invention;

FIGS. 4A to 4D schematically represent a system for providing audio data according to embodiments of the invention;

FIG. 5 schematically represents a system for providing audio data according to an embodiment of the invention;

FIG. 6 schematically represents an example of software and hardware architecture of a device for providing audio data according to an embodiment of the invention;

FIG. 7 schematically represents an example of functional architecture of a device for providing audio data according to an embodiment of the invention.

### DESCRIPTION OF THE EMBODIMENTS

This invention relates to a method for providing audio data, and associated device, system, computer program and information medium.

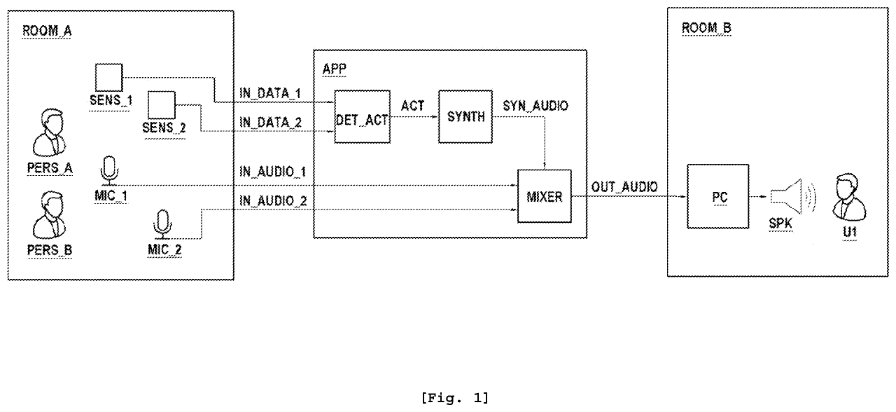

FIG. 1 schematically represents a system for providing audio data according to an embodiment of the invention.

In particular, FIG. 1 illustrates an exemplary implementation wherein the proposed system for providing audio data in accordance with the invention is exploited to implement a videoconferencing service. This exemplary implementation is described for illustration purposes and is without any limitation.

The system proposed according to this embodiment comprises: sensors SENS_1 and SENS_2; devices MIC_1 and MIC_2 for capturing audio data; a device APP for providing audio data; and a device PC for reproducing audio data.

In this example, it will be considered that a meeting room ROOM_A is equipped with the sensors SENS_1 and SENS_2 and the devices MIC_1 and MIC_2. In this meeting room ROOM_A, several persons PERS_A and PERS_B are present and are involved in a videoconferencing meeting. Thus, during the meeting, the devices MIC_1 and MIC_2 capture first audio data IN_AUDIO_1 and IN_AUDIO_2 and the sensors SENS_1 and SENS_2 sense measured data IN_DATA_1 and IN_DATA_2. It is assumed, in this example, that the sensors SENS_1 and SENS_2 are cameras filming the meeting room ROOM_A and the devices MIC_1 and MIC_2 are terminals equipped with microphones capturing the voices of the persons PERS_A and PERS_B.

According to this example, the device APP takes as input the first audio data IN_AUDIO_1 and IN_AUDIO_2 as well as the measured data IN_DATA_1 and IN_DATA_2.

By means of a detector DET_ACT, the device APP detects, based on the data measured IN_DATA_1 and IN_DATA_2, the activities ACT of the persons PERS_A and PERS_B during the videoconference meeting as well as the activities ACT associated with the meeting room ROOM_A. By way of illustration, the device APP detects, based on images produced by the cameras SENS_1 and SENS_2, that the person PERS_A is standing up, approaching a blackboard and starting a presentation. Thus, the device detects an activity for example characterized by the following description attribute: “A presentation is starting.” According to another example the device APP detects, based on measured data IN_DATA sensed by a pressure sensor SENS, that a door of the meeting room ROOM_A is open, such an activity ACT being for example characterized by the attribute: “A door of the meeting room has opened”.

By means of a generator SYNTH, the device APP generates second audio data SYN_AUDIO representative of the detected activities ACT. For example, the second audio data SYN_AUDIO may comprise an audio message in speech synthesis announcing: “A presentation is starting.”

By means of a mixer MIXER, the device APP mixes (i.e. combines) the first audio data IN_AUDIO1 and IN_AUDIO2 (i.e. the voices of the persons) and the second audio data SYN_AUDIO (i.e. the activity audio data) to produce mixed audio data OUT_AUDIO. Thus, the mixed audio data OUT_AUDIO comprise, in this example, an enriched audio channel combining the voices of the persons PERS_A and PERS_B with the activities audio data SYN_AUDIO.

In this example, the device APP provides enriched audio data OUT_AUDIO to a reproduction device PC. This reproduction device PC is located in a remote meeting room ROOM_B in which a user U1 is present. The reproduction device PC is, by way of illustration, a terminal equipped with a loudspeaker SPK. Thus, during the meeting, the terminal PC receives coming from the device APP an audio stream OUT_AUDIO and reproduces it with the loudspeaker SPK.

The device APP thus allows to enrich an audio stream associated with a meeting with audio information representative of the detected activities. The progress of the meeting is therefore reproduced in a more complete and more accessible manner to the users. Specifically, the enriched audio data allow to describe, by the audio modality alone, information that is normally accessible via several modes, particularly audio and video.

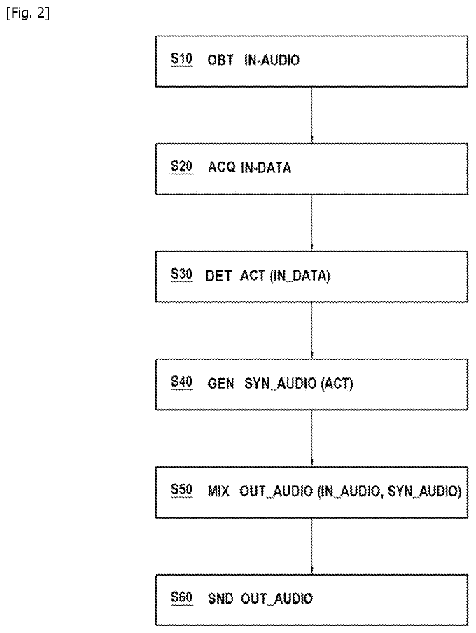

FIG. 2 represents, in the form of a block diagram, the steps of a method for transmitting audio data according to an embodiment of the invention.

According to an embodiment illustrated by FIG. 2, the proposed method for providing audio data is implemented by the device APP and comprises at least one of the steps described hereinafter.

During a step S10, the device APP obtains first audio data IN_AUDIO.

In the scope of the invention, the term “audio data”, is used to refer to computer data for representing one or more audio channels (i.e. audio streams, acoustic signals). In the remainder of the text, first audio data will also be referred to by the expression “base audio data”.

In particular, according to a variant embodiment, the device APP captures first audio data IN_AUDIO using devices MIC for capturing audio configured to capture audio data. Such capturing devices MIC are capable of converting an acoustic signal into audio data, and correspond for example to terminals comprising a microphone or being configured to communicate with a microphone, etc. Typically, the first audio data IN_AUDIO correspond to the audio channels (i.e. audio signals) captured by one or more microphones with which a videoconferencing room ROOM_A is equipped.

In the scope of the invention, other variants could also be envisaged wherein the device APP receives the first audio data IN_AUDIO coming from a storage device storing these data in its memory.

During a step S20, the device APP senses the measured data IN_DATA using at least one sensor SENS.

In the scope of the invention, the term “measured data” refers to data produced by one or more sensors, or produced based on measurements taken by one or more sensors. More specifically, the measured data are non-audio data used to detect activities of persons or of places. Typically, the measured data are, for example, produced by connected objects (more commonly referred to by the term IoT, an acronym for Internet of Things) with which a videoconference room is equipped.

Thus, according to a variant embodiment, the device APP senses measured data IN_DATA using the sensors SENS. Within the meaning of the invention, a “sensor” denotes a device converting the state of a physical quantity into a usable quantity (e.g. an electrical voltage). For example the sensors SENS can belong to the following set of sensors: a video camera; a network probe; a pressure sensor; a temperature sensor; a depth sensor; and a thermal camera. By way of illustration, the measured data IN_DATA may comprise a plurality of images acquired by one or more video cameras filming a meeting room ROOM_A.

According to other variant embodiments, the device APP receives the measured data IN_DATA coming from a storage device storing these data in the memory.

During a step S30, the device APP detects at least one activity ACT based on measured data IN_DATA, particularly by means of one or more sensors SENS. More precisely, the device APP analyzes the measured data IN_DATA, sensed by at least one sensor SENS, to detect the activities ACT.

In the scope of the invention, a detected activity ACT is described by a description attribute and a detection time. An activity within the meaning of the invention may denote an activity of at least one person or an activity of at least one place.

A detected activity ACT can in particular be a local activity, i.e. an activity particular to a place or to a group of people. Such a local activity may thus denote: an activity of one or more persons in a place (e.g. one of the participants of a videoconference in a videoconference room speaking); or an activity of this place (e.g. the launching of a slide show in a videoconference room). A “local activity” may also be referred to by the term “local event”.

The term “activity of persons” here refers to an action performed by at least one person. An activity detected by the device APP can for example belong to the following set of activities: the starting or ending of a presentation by a person; a conversation between persons, a person entering or leaving a room, a journey or a movement of a person, an expression of a person (e.g. a smile) etc. By way of example the device APP detects, based on images IN_DATA captured by a video camera SENS, that a person has entered the meeting room ROOM_A. Moreover, one or more persons can be the subjects or complements of a detected activity, e.g. a person PERS_A referring to another person PERS_B.

The term “activity of place” here refers to an activity associated with a place, and thus to all changes in the place not associated with a person. For example, an activity associated with a place can for example belong to the following set of activities: a start or an end of the reading of a multimedia content (e.g. launch of a slide show, start of a playing of a film, etc.); an opening or closing of a door; turning on and off of the lights etc. By way of illustration, the device APP detects, based on data IN_DATA measured by a sensor SENS, that a reading of a multimedia content has started.

The details of implementation of the step S30 of detecting activities are for example described in the following documents: Florea and al., “Multimodal Deep Learning for Group Activity Recognition in Smart Office Environments”, Future Internet, 2020; Krishnan and al., “Activity recognition on streaming sensor data”, Pervasive and Mobile Computing, Volume 10, 2014.

Furthermore, the device APP can identify persons associated with detected activities ACT. Such a step of identification of a person can in particular be implemented using voice or face recognition techniques, or by exploiting a network probe and the identifier of a terminal associated with a person, etc. For example, the device APP can, based on images IN_DATA captured by a camera SENS, detecting that a person PERS_A has entered the meeting room ROOM_A and identifying that this person PERS_A is Ms X. According to another example, the first audio data IN_AUDIO can also be used by the device APP to identify one or more persons, particularly by using voice recognition techniques.

It should be emphasized that, in the scope of the invention, the identification of persons can be done by name, but it can also be envisaged to identify persons anonymously by respectively assigning them identifiers that are not names.

During a step S40, the device APP generates second audio data SYN_AUDIO representative of said at least one detected activity ACT.

According to an embodiment, the step S40 of generating second audio data SYN_AUDIO includes a conversion (i.e. a transformation) into detected audio activities ACT. The second audio data SYN_AUDIO are hereinafter also referred to as “activity audio data”.

According to an embodiment, the second audio data SYN_AUDIO comprise sound icons associated with the detected activities, the sound icons may be recorded, generated by computer, etc. In this embodiment, the device APP generates the sound icon corresponding to the detected activity ACT. By way of illustration, following the detection of the entrance of Ms X in the meeting room ROOM_A, the device APP generates an associated sound icon, such as a bell ring.

According to an embodiment, the device APP generates audio messages in speech synthesis representative of the detected activities ACT. By way of example, the device APP synthesizes a speech signal announcing the following message: “Ms X has entered the meeting room.” Thus, according to this embodiment, the second audio data SYN_AUDIO comprises one or more audio messages in speech synthesis. In particular, the synthesis of a speech signal can be done by means of a computer program of “Text-to-Speech” type.

The term “audio message in speech synthesis” refers to one or more speech signals generated by computer with a synthetic voice (i.e. speech synthesis).

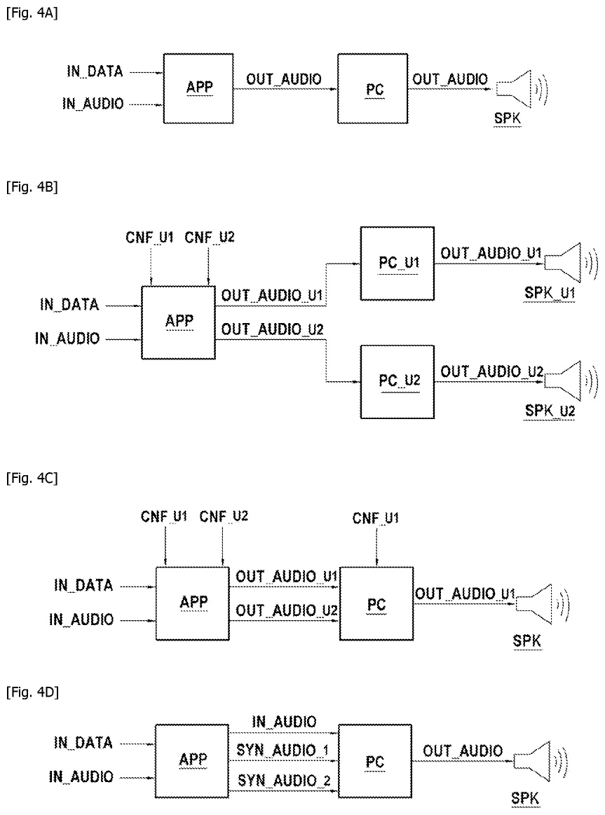

In particular, the step S40 of generating the second audio data SYN_AUDIO can be parameterized by one or more user parameters CNF_U1, CNF_U2. For example, a user parameter can characterize the language of the user (e.g. French or English), such that the synthesized speech signal SYN_AUDIO announces a message in this language. Such a parameterization of the step S40 is more fully described hereinafter with reference to FIGS. 4A to 4D.

During a step S50, the device APP mixes the first audio data IN_AUDIO and the second audio data SYN_AUDIO. In this way, the device APP obtains mixed audio data OUT_AUDIO.

In step S50 the proposed method performs a digital combination of source audio channels (the first and second audio data) to obtain at the output at least one audio channel (the mixed audio data). Hereinafter, said mixed audio data obtained by the method will also be denoted by the expression “enriched audio data”. This expression refers to the fact that the base audio data are enriched by the method with the activity audio data.

For example, the device APP combines in this step the first audio data IN_AUDIO, corresponding to sounds captured in the meeting room ROOM_A, with the second audio data SYN_AUDIO, corresponding to an audio message in speech synthesis announcing the entrance of Ms X. In this example, the device APP provides as output enriched audio data OUT_AUIO comprising an audio channel combining the voices of the persons taking part in the meeting with the audio message in speech synthesis announcing the entrance of a person into the meeting room ROOM_A.

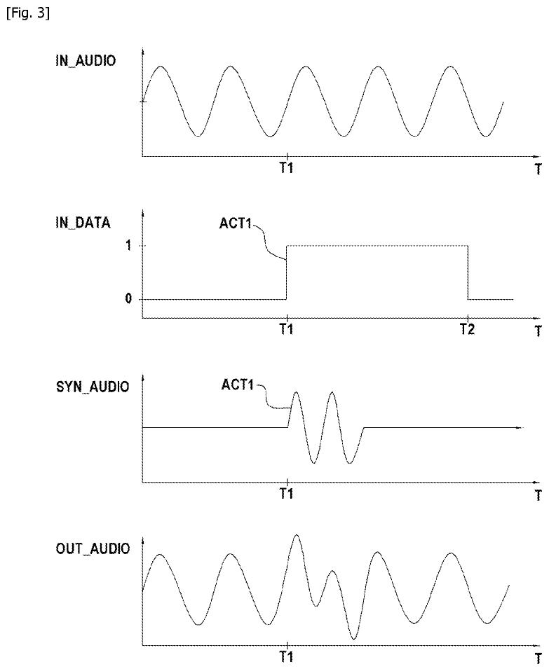

Note that, according to an embodiment described hereinafter with reference to FIG. 3, the mixing step S50 is performed synchronously.

As described hereinafter with reference to FIGS. 4A to 4D, the mixing step S50 can be parameterized by one or more user parameters.

Also with reference to FIGS. 4A to 4D, in the step S50 the device APP can perform a plurality of mixes as a function of different user parameters, such that the mixed audio data OUT_AUDIO comprise a plurality of audio channels.

In the scope of the invention, the term “audio channels” refers here to audio streams respectively corresponding to separate acoustic signals (i.e. an audio signal, or an audio track).

According to an embodiment, the generation of second audio data representative of an activity is immediately consecutive to the detection of this activity and in which the mixing of first audio data and these second audio data is immediately consecutive to the generation of these second audio data. Thus, the mixing of the first audio data and the second generated audio data based on the activities detected based on measured data is performed as soon as the measured data are sensed. This embodiment allows a user to receive live audio data thus enriched with the activity data.

Typically, for the audio stream of a videoconference, a latency (i.e. transmission time between the source and destination) less than 100 milliseconds is required; beyond this time limit, the transmission time of the audio data can be perceptible by remote users during a conversation and thus degrade the experience of the users. For example, it is advantageous that the method according to this embodiment, when an activity is detected, generates the second audio data associated with this activity and combines them with the first audio data without significantly increasing the latency. In this way, remote users may converse without perceiving any delay while having live access to an enriched audio content and therefore a better understanding of a meeting.

During a step S60, the device APP provides the mixed audio data OUT_AUDIO.

In particular, the mixed audio data OUT_AUDIO are, according to a variant embodiment, transmitted to one or more reproduction devices PC, such as terminals comprising loudspeakers or configured to control loudspeakers. In accordance with the invention, the reproduction devices PC may denote any type of terminal such as laptop or desktop computers, mobile telephones, Smartphones, tablets, projectors etc. Such reproduction devices are capable of converting audio data into an acoustic signal. This is particularly the case of local or remote reproduction devices PC.

According to an embodiment, the mixed audio data OUT_AUDIO are transmitted to local reproduction devices PC (i.e. on a same local network as the device APP). For example, returning to the example of FIG. 1, a user of a reproduction device PC receiving the mixed audio data OUT_AUDIO may be one of the persons PERS_A or PERS_B in the meeting room ROOM_A, persons for whom an activity can be detected and described by the second audio data SYN_AUDIO in the mixed audio data OUT_AUDIO.

According to another embodiment, the mixed audio data OUT_AUDIO are transmitted to remote reproduction devices PC. Taking again the example of FIG. 1, the user U1 of a reproduction device PC receiving the mixed audio data OUT_AUDIO can be remote in a meeting room ROOM_B. In this embodiment, the mixed audio data OUT_AUDIO are provided to a transmission device COM for transmission over a communication network (e.g. telephone, videophone, broadcast, Internet, etc.) with a view to being output by remote reproduction devices PC.

However, in the scope of the invention, other variant embodiments are also possible. For example it could be envisaged to provide the mixed audio data OUT_AUDIO to one or more storage devices for storage in their memory, which would allow to access the enriched audio content later.

Of course, no limitation is attached to the format for encoding audio data, which can be encoded with any protocol known to those skilled in the art. Similarly, no limitation is attached to the nature of the communication interfaces between the proposed device APP and, respectively: the devices MIC for capturing audio data; the sensors SENS; and the reproduction devices PC, which can be wired or wireless, and can implement any protocol known to those skilled in the art (Ethernet, Wi-Fi (trademark), Bluetooth (trademark), 3G, 4G, 5G, 6G, etc.).

The proposed method has a particularly advantageous application for the implementation of videoconferencing systems. Owing to the combination of the activity audio data with the base audio data, the proposed method allows to reproduce the activities related to a videoconference through the audio modality. By way of example, the proposed method allows, among other things, to follow a meeting remotely in audio only, while having access to information concerning the progress of the meeting. By comparison with existing videoconferencing systems, a remote user hears not only the voices and sounds captured in a meeting room but also accesses the activity audio data. The proposed method thus allows to improve the reproduction of a meeting or of a presentation during a videoconference, and, thus, to improve the experience of the users of a videoconferencing system.

It should be emphasized that the proposed method allows to significantly improve digital accessibility to videoconferencing services. Indeed, the proposed method for example allows visually impaired persons to access an enriched audio content during a videoconference, and thus have a better understanding of the progress of a meeting.

FIG. 3 schematically represents an example of data obtained and processed by a system of transmission of audio data according to an embodiment of the invention.

FIG. 3 illustrates data processed by the device APP including, in particular, the following: first audio data IN_AUDIO (e.g. sounds captured by a microphone MIC of a meeting room ROOM_A); measured data IN_DATA (e.g. data of a pressure sensor SENS installed on a door of a room ROOM_A); a detected activity ACT1 (e.g. the entrance of a person into the room ROOM_A, a slide show being launched) detected at the time T1; second audio data SYN_AUDIO (e.g. a sound icon to announce the entrance of a person); and mixed audio data OUT_AUDIO (e.g. an enriched audio channel combining the captured sounds IN_AUDIO and the sound icon SYN_AUDIO).

As illustrated by FIG. 3, according to an embodiment, the device APP synchronously mixes the first audio data IN_AUDIO and the second audio data SYN_AUDIO.

We are here using the term “synchronous mixing” to refer to the fact that: for an activity detected at a given time, the first and second audio data are synchronized such that the start of the second audio data associated with this activity coincides with the first audio data captured at the time of detection of this activity. In other words, the synchronous mixing is done in such a way that, in the output audio stream, the start of the second audio data of an activity corresponds to the time of detection of the activity.

To describe the synchronous nature of the mixing performed by the device APP, the following example will be considered. In step S30, the device APP detects, based on measured data IN_DATA, an activity ACT1. This activity ACT1 is characterized by a description attribute and a detection time T1. In step S40, the device APP generates second audio data SYN_AUDIO representative of the activity ACT1. In step S50, the device APP mixes (i.e. combines) the first audio data IN_AUDIO and the second audio data SYN_AUDIO to obtain an output audio channel OUT_AUDIO. The mixing is referred to as synchronous when, in the output audio channel OUT_AUDIO, the time T1 in the first audio data IN_AUDIO coincides with the start of the second audio data SYN_AUDIO.

In other words, the device APP synchronizes during the mixing: the start of the second audio data SYN_AUDIO associated with the activity ACT1 detected at the time T1; with the time T1 in the first audio data IN_AUDIO.

FIGS. 4A to 4D schematically represent a system for providing audio data according to embodiments of the invention, these embodiments can be combined.

According to a first embodiment, illustrated by a FIG. 4A, the device APP takes as input the first audio data IN_AUDIO and the measured data IN_DATA ; and provides at its output the mixed audio data OUT_AUDIO enriched with the second audio data SYN_AUDIO.

In this embodiment, the enriched audio data OUT_AUDIO comprise a single audio channel, for example an audio channel combining the voices of the persons taking part in a meeting with the activity audio data. The enriched audio data OUT_AUDIO are, according to this embodiment, provided to a reproduction device PC which reproduce the audio channel OUT_AUDIO by means of a loudspeaker SPK.

According to a second embodiment, illustrated by FIG. 4B, the device APP is parameterized by user parameters CNF_U1 and CNF_U2 respectively associated with the users of the reproduction devices PC_U1 and PC_U2. In other words, the enriched audio data OUT_AUDIO are obtained as a function of the user parameters CNF_U1 and CNF_U2.

In the scope of the invention, a user parameter denotes an input parameter of the proposed method such that the enriched audio data are obtained as a function of this parameter. For example, a user parameter can in particular denote: a type of activity to be described by the audio modality (e.g. activities of persons, or activities of places, or both); a type of description of the activities (e.g. detailed description, or simplified description; sound icons, or speech synthesis); language preferences (e.g. formal, or familiar); a language (e.g. French or English); a type of profile of the user; a privacy level; user preferences etc.

It is important to note here that a user parameter can be defined beforehand or defined during a reproduction. Furthermore, a user parameter can be defined by the user or by an administrator.

Taking again the example described with reference to FIG. 2, the activity audio data SYN_AUDIO comprise an audio message in speech synthesis announcing the entrance of a person. It is assumed, for example, that the user parameters CNF_U1 and CNF_U2 characterize two different privacy levels. For the first user parameter CNF_U1, the audio message in speech synthesis announces: “Ms X has entered the meeting room.”; while, for the second parameter CNF_U2, the audio message in speech synthesis announces: “A person has entered the meeting room.”

In this embodiment, the enriched audio data OUT_AUDIO provided by the device APP comprise a plurality of audio channels OUT_AUDIO_U1 and OUT_AUDIO_U2. More precisely, the device APP performs, for each of the user parameters CNF_U1 and CNF_U2, mixing and generating steps so as to obtain a plurality of audio channels OUT_AUDIO_U1 and OUT_AUDIO_U2. In this embodiment, for a detected activity ACT, the step of generating second audio data SYN_AUDIO differs as a function of a user parameter CNF_U1 or CNF_U2.

Thus, for example, the first audio channel OUT_AUDIO_U1 comprises the audio message with the identity of the person and the second audio channel OUT_AUDIO_U2 comprises the anonymous audio message. The enriched audio channels OUT_AUDIO_U1 and OUT_AUDIO_U2 are transmitted to the reproduction devices PC_U1 and PC_U2 each equipped respectively with a loudspeaker SPK_U1 and SPK_U2. In this way, the users of the devices PC_U1 and PC_U2 respectively have access to different levels of information.

This embodiment allows providing an audio content with different levels of privacy. For example, a first audio channel enriched with activity data comprising the names of the persons is provided to a first group of persons (e.g. the employees of a company); and a second audio channel enriched with anonymous activity data is provided to a second group of persons (e.g. persons external to the company).

According to another example, the user parameters CNF_U1 and CNF_U2 can also characterize different types of description of the activities. By way of illustration, it is assumed here that the user parameters CNF_U1 and CNF_U2 respectively characterize a simplified level and a detailed level of description of the detected activities ACT. Thus, following the launching of a slide show, the second audio data SYN_AUDIO can for example comprise: for the first user parameter: CNF_U1 (i.e. simplified description), an audio message announcing: “A presentation is beginning”; and, for the second parameter CNF_U2 (i.e. detailed description), an audio message announcing: “A presentation, called On the development of mobile telephone networks, is beginning and is presented by Mr Y”.

This embodiment allows to adapt the audio content transmitted as a function of the users. This particularly allows providing different versions of an audio content associated with a meeting. As illustrated by the examples described here, this embodiment particularly allows providing a plurality of audio channels with different types of enrichment.

In the scope of the invention, a “version of an audio content” can for example denote: an

audio channel with only the base audio data; or an audio channel combining the base audio data and the activity audio data. Also, different versions of an audio content can denote audio channels combining the base audio data with audio data of activities respectively obtained as a function of different user parameters.

Note that the parameterization of the device APP as described here can be done during the step S40 of generating second audio data SYN_AUDIO and/or during the mixing step S50.

Furthermore, for a given remote user, the selection of the audio channel can be done either upstream of the conveying of audio data (i.e. by the device implementing the proposed method), or downstream (i.e. via the reproduction device) as described hereinafter.

According to a third embodiment, illustrated by FIG. 4C, the device APP is parameterized by user parameters CNF_U1 and CNF_U2.

It is assumed here, by way of example, that the user parameters CNF_U1 and CNF_U2 characterize two languages: French; and English. In addition, the device APP detects the entrance of a person into a meeting room. Thus, the device APP generates, as a function of the user parameters CNF_U1 and CNF_U2, activity audio data SYN_AUDIO announcing the entrance of a person. For the first parameter CNF_U1, the activity audio data SYN_AUDIO comprise an audio message in speech synthesis announcing in French: “Une personne est entrée dans la salle de ré union.” For the second parameter CNF_U2, the second audio data SYN_AUDIO comprise an audio message in speech synthesis announcing in English: “Someone entered the meeting room.”

In this embodiment, the device APP provides at its output enriched audio data comprising a plurality of audio channels OUT_AUDIO_U2 and OUT_AUDIO_U1: an audio channel with activity data in French; and an audio channel with activity data in English. The audio channels OUT_AUDIO_U1 and OUT_AUDIO_U2 are provided to one and the same reproduction device PC. In this way, the user of the device PC can thus select the audio channel he wishes to reproduce. For example, the user of the device PC selects the French audio channel and thus accesses the audio message: “Une personne est entrée dans la pièce.”.

This embodiment thus allows the recipients to choose the type of enrichment they wish to access.

According to a fourth embodiment, illustrated by FIG. 4D, the device APP provides at its output an audio channel with first audio data IN_AUDIO and at least one audio channel with second audio data SYN_AUDIO_1, SYN_AUDIO_2. Each of the audio channels SYN_AUDIO_1, SYN_AUDIO_2 with activity data can comprise second audio data respectively obtained as a function of different user parameters. For example, the audio channels SYN_AUDIO_1, SYN_AUDIO_2 may comprise activity audio data respectively representative of different types of activity.

In this embodiment, the audio channels provided by the device APP are, for example, transmitted to one or more reproduction devices PC. In this way, a reproduction device PC can, during a meeting, select at least one audio channel to be reproduced and potentially mix several of them. Note that, in this embodiment, the step S50 of mixing the first audio data IN_AUDIO and second audio data SYN_AUDIO_1, SYN_AUDIO_2 can thus be performed by the reproduction device PC.

For example, the reproduction device APP can provide at its output the following audio channels: a channel IN_AUDIO with the base audio data; a channel SYN_AUDIO_1 with activity audio data of a first type (e.g. activities of persons); and a channel SYN_AUDIO_2 with activity audio data of a second type (e.g. activities of place). The audio channels IN_AUDIO, SYN_AUDIO_U1, and SYN_AUDIO_2 are provided to reproduction devices PC. Thus, a user of a reproduction device PC can select the audio channel or channels he wishes to reproduce. For example, the user of the device PC can select only the audio channel IN_AUDIO, or combine the channels IN_AUDIO and SYN_AUDIO_1, or combine the channels IN_AUDIO and SYN_AUDIO_2, or any other combination of these channels.

This embodiment allows a user of a reproduction device to select the audio content he wishes to access, etc. an enriched or non-enriched audio content, an audio content enriched with a certain type of activity, etc. In particular, during a meeting, a user can thus cause the reproduced audio content to vary.

For example, the audio data provided to a reproduction device may comprise two audio channels: a first comprising only the base audio data (e.g. the sounds captured in a meeting room); and a second audio channel comprising the activity audio data. It is assumed that a remote user is attending a videoconferencing meeting and listening to the first audio channel with only the base audio data. If this remote user wishes to temporarily view another document to confirm an item of information, he can then combine the two channels with the base audio data and the activity audio data. In this way, the remote user can look away from the images of the meeting in progress for a few moments, without losing the important information relating to the progress of the meeting.

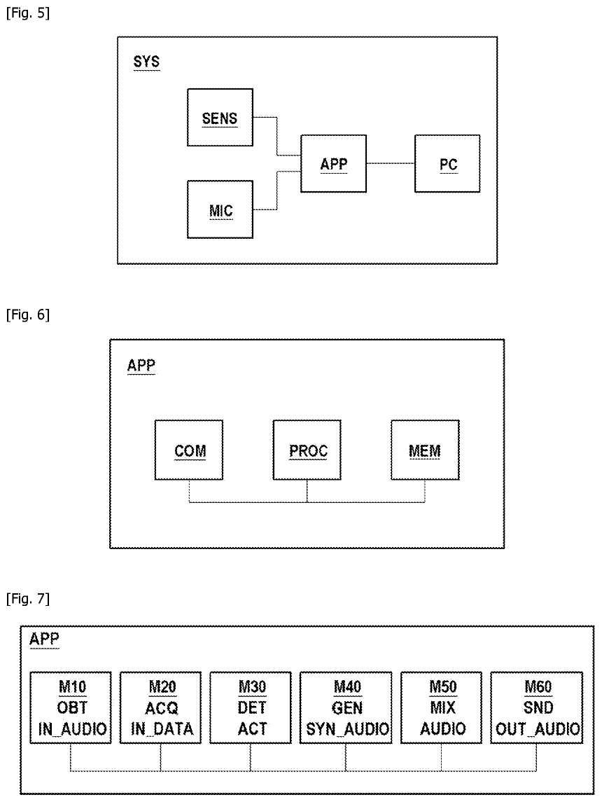

FIG. 5 schematically represents a system for providing audio data according to an embodiment of the invention.

As illustrated by FIG. 5, according to an embodiment, the system SYS comprises at least one of the following elements: a device APP for providing audio data; at least one sensor SENS configured to sense measured data IN_DATA and to communicate with the device APP; at least one capturing device MIC configured to capture first audio data IN_AUDIO and to communicate with the device APP; and at least one reproduction device PC configured to communicate with the device APP and to reproduce audio data OUT_AUDIO.

FIG. 6 schematically represents an example of software and hardware architecture of a device for providing audio data according to an embodiment of the invention.

As illustrated by FIG. 6, according to an embodiment, the device APP for providing audio data possesses the hardware architecture of a computer. The device APP includes, according to a first exemplary embodiment, a processor PROC, a random access memory, a read-only memory MEM, and a non-volatile memory. The memory MEM constitutes an information medium (i.e. a recording medium) in accordance with the invention, readable by a computer and on which is recorded a computer program PROG. The computer program PROG includes instructions for implementing the steps performed by the device APP of a method according to the invention, when the computer program PROG is executed by the processor PROC. The computer program PROG defines the functional elements represented hereinafter by FIG. 7, which are based on or control the hardware elements of the device APP.

As illustrated by FIG. 6, according to an embodiment, the device APP has a communication device COM configured to communicate with at least one of the following elements: at least one sensor SENS; at least one device for capturing audio data MIC; and at least one reproduction device PC.

FIG. 7 schematically represents an example of functional architecture of a device for providing audio data according to an embodiment of the invention.

As illustrated by FIG. 7, according to an embodiment, the device APP for providing audio data comprises at least one of the following elements:
an obtainer M10 configured to obtain first audio data IN_AUDIO;
a receiver M20 configured to receive measured data IN_DATA by one or more sensors SENS;
a detector M30 configured to detect activities ACT based on measured data IN_DATA;
a generator M40 configured to generate second audio data SYN_AUDIO representative of the detected activities ACT;
a mixer M50 configured to mix first audio data IN_AUDIO and the second audio data SYN_AUDIO and thus produce mixed data OUT_AUDIO; and
a provider M60 configured to provide mixed audio data OUT_AUDIO.

Different examples of use of the proposed device for providing audio data are presented herein, these examples being described by way of illustration and being without any limitation.

According to a first example of use, a user U1 participates in a remote meeting with persons PERS_A and PERS_B present in a meeting room ROOM_A. The user receives mixed audio data OUT_AUDIO provided by the proposed device APP. Using the first audio data IN_AUDIO, the user U1 can follow by telephone everything that is said during the meeting by the different persons PERS_A and PERS_B. And, owing to the second audio data SYN_AUDIO representative of the detected activities ACT, the user U1 becomes aware of the entrances of persons, launches of slide shows, starting or ending of various activities, which allows him to better understand and better locate the speech he hears from the persons PERS_A and PERS_B and certain noises.

According to a second example of use, a user U1 was not able to attend a progress meeting of the project in which this user U1 is taking part. The user decides to access the audio recording of the meeting which has been made and thus accesses the mixed audio data OUT_AUDIO provided by the proposed device APP. By way of this audio recording, the user U1 relives the meeting as if he had attended, knowing who arrived, when, that certain voice exchanges corresponded to the presentation of a slide show, but that subsequent exchanges were taking place outside of the presentation.

According to a third example of use, two users U1 and U2 attend a same presentation of a company A. The user U1 is an employee of the company A, which is not the case of the user U2. The two users U1 and U2 directly access mixed audio data OUT_AUDIO provided by the device APP, comprising the base audio data IN_AUDIO of the meeting enriched by the activity audio data SYN_AUDIO. However, the users U1 and U2 do not access the same level of detail. Specifically, in this example, several versions of the activity audio data SYN_AUDIO are transmitted and filtered at the receiver as a function of the user parameters CNF_U1 and CNF_U2 (e.g. profile, rights) of the users U1 and U2.

According to a fourth example of use, a user U1 is following a remote meeting. The user U1 has an audio headset SPK connected to a terminal PC which allows him to listen to everything that is said during the meeting and sees on a screen of the terminal PC the retransmission in images of the meeting room ROOM_A. At one time, the user U1 want to check the content in images of another independent video to support his argument when it will be his turn to speak. Thus, the user U1 decides to activate the sound “audio atmosphere” by enrichment of the captured audio IN_AUDIO through the mics MIC in the meeting room ROOM_A. The user U1 thus now has in his audio headset SPK the mixing of the base audio data IN_AUDIO and the activity audio data SYN_AUDIO provided by the proposed device APP. This allows him to turn away from the images of the meeting in progress for a few moments, without losing important information from the activities ACT not perceived by the base audio IN_AUDIO.

Note that the order in which the steps of the method as previously described follow one another, particularly with reference to the appended drawings, constitutes only an exemplary embodiment without any limitation, variants being possible. Moreover, the reference signs are not limiting of the scope of the protection, their sole function being to simplify the understanding of the claims.

Those skilled in the art will understand that the embodiments and variants described constitute only non-limiting exemplary implementations of the invention. In particular, those skilled in the art may envision any adaptation or combination of the embodiments and variants described above in order to meet a specific need.

1. A method for providing audio data, said method being implemented by a device and comprising:
receiving data measured by at least one non-audio sensor;
detecting at least one activity based on the received data; and
creating second audio data representative of the at least one detected activity, said second audio data being adapted to be mixed with first captured audio data.

2. The method of claim 1 comprising sensing said measured data by said at least one sensor based on which said at least one activity is detected.

3. The method of claim 1 wherein said second audio data comprise at least one audio message in speech synthesis.

4. The method of claim 1 comprising mixing said first audio data and said second audio data.

5. The method of claim 4 wherein said mixing of said first audio data and said second audio data is performed synchronously.

6. The method of claim 4 wherein said creating said second audio data representative of said activity is immediately consecutive to the detection of this activity and wherein said mixing of said first audio data and said second audio data is immediately consecutive to said creating the second audio data.

7. The method of claim 4 wherein the mixed audio data comprise several audio channels.

8. The method of claim 4 wherein the creating said second audio data is performed as a function of at least one user parameter of a user of a reproduction device that is a recipient of the mixed audio data.

9. The method of claim 7 wherein the creating said second audio data is performed as a function of at least one user parameter of a user of a reproduction device that is a recipient of the mixed audio data, and wherein said several audio channels are respectively obtained as a function of different user parameters.

10. The method of claim 1 comprising identifying at least one person associated with said at least one detected activity, said second audio data being created based on a result of said identifying.

11. A device for providing audio data, said device comprising:
a processor; and
a non-transitory computer readable medium comprising instructions stored thereon which when executed by the processor configure the device to:
receive data measured by at least one non-audio sensor;
detect at least one activity based on the received data; and
create second audio data representative of the at least one detected activity, said second audio data being adapted to be mixed with first captured audio data.

12. A system comprising:
at least one non-audio sensor, which senses measured data;
at least one capturing device configured to capture first audio data; and
a device for providing audio data, which comprises:
a processor; and
a non-transitory computer readable medium comprising instructions stored thereon which when executed by the processor configure the device to:
receive data measured by the at least one non-audio sensor;
detect at least one activity based on the received data; and
create second audio data representative of the at least one detected activity, said second audio data being adapted to be mixed with the first audio data.

13. The system of claim 12 comprising at least one reproduction device configured to communicate with said device for providing audio data and to reproduce audio data.

14. The system of claim 12 wherein said at least one non-audio sensor comprises a sensor from among the following: a video camera; a network probe; a pressure sensor; a temperature sensor; a depth sensor; or a thermal camera.

15. The system of claim 12 wherein said system is a videoconferencing system.

16. A non-transitory computer readable medium having stored thereon instructions which, when executed by a processor, cause the processor to implement a method comprising:
receiving data measured by at least one non-audio sensor;
detecting at least one activity based on the received data; and
creating second audio data representative of the at least one detected activity, said second audio data being adapted to be mixed with first captured audio data.
